(19) United States
(12) Patent Application Publication
(10) Pub. No.: US 2018/0027641 A1
(43) Pub. Date: Jan. 25, 2018

(54) X-Ray Source Controller

(71) Applicant: Moxtek, Inc., Orem, UT (US)

(72) Inventors: Chris Carter, Spanish Fork, UT (US); Jerry Smith, Centerville, UT (US)

(21) Appl. No.: 15/586,880

(22) Filed: May 4, 2017

Related U.S. Application Data
(60) Provisional application No. 62/364,659, filed on Jul. 20, 2016.

(51) Int. Cl. H05G 1/46; H05G 1/10

(52) U.S. Cl. CPC H05G 1/46; H05G 1/10

(57) ABSTRACT

An x-ray source can include a power supply and an x-ray tube. The power supply can include digital-to-analog converters (DACs) electrically-coupled between a digital controller and an x-ray tube control circuit. A user of the x-ray source can provide a digital input to the digital controller for operation of the x-ray source. Advantages of this power supply can include easy operation of the x-ray source, minimize problems in x-ray source operation due to variation between manufactured x-ray tubes, and reduced electronic noise. There can be a small distance between the DACs and the x-ray tube control circuit. The power supply electronic components can be part of a single electronic circuit rigidly-mounted together. The digital controller, the first DAC, the second DAC, and the x-ray tube control circuit can be rigidly-mounted within a housing.

### CLAIM OF PRIORITY

This application claims priority to U.S. Provisional Patent Application No. 62/364,659, filed on Jul. 20, 2016, which is incorporated herein by reference in its entirety.

### FIELD OF THE INVENTION

The present application is related generally to x-ray sources.

### BACKGROUND

An x-ray source can include an x-ray tube and a power supply. Analog signals can control the x-ray tube. The analog signals can include a pair of voltages, one of which controls a voltage differential across the x-ray tube and the other of which controls an electrical current flow through an electron emitter (e.g. filament).

The x-ray source can be supplied by an x-ray source manufacturer. A user of the x-ray source, or a subsequent manufacturer who incorporates the x-ray source into another device, can supply the analog signals. The analog signals can be transferred to the x-ray source by a cable, typically with a length of many centimeters.

There are problems of the above configuration. For example, the user or subsequent manufacturer may have difficulty providing proper analog input, due to the need for additional equipment to develop the analog signals. Also, due to variation in manufacture of the x-ray tube, the same analog signals can result in variation in x-ray tube output. Another problem is electronic noise resulting from transfer of the voltages of the analog signals across the cable.

### SUMMARY

It has been recognized that it would be advantageous to make operation of an x-ray source easier for the user, avoid or minimize problems in x-ray source operation due to variation between manufactured x-ray tubes, and reduce electronic noise associated with control of an x-ray source. The present invention is directed to various embodiments of a power supply for an x-ray tube that satisfy these needs. Each embodiment may satisfy one, some, or all of these needs.

The power supply for the x-ray tube can comprise a digital controller, a first digital-to-analog converter (first DAC), a second digital-to-analog converter (second DAC), and an x-ray tube control circuit. The digital controller can emit a first digital signal to indicate a desired x-ray tube voltage and a second digital signal to indicate a desired x-ray tube electrical current for an electron emitter. The first DAC can be electrically-coupled to the digital controller, can receive the first digital signal, and can emit a voltage corresponding to the first digital signal, defining a first analog signal. The second DAC can be electrically-coupled to the digital controller, can receive the second digital signal, and can emit a voltage corresponding to the second digital signal, defining a second analog signal. The x-ray tube control circuit can be electrically-coupled to the first DAC, can receive the first analog signal, and can provide a voltage differential to the x-ray tube based on the first analog signal. The x-ray tube control circuit can also be electrically-coupled to the second DAC can receive the second analog signal, and can provide an electrical current to the electron emitter based on the second analog signal.

In one embodiment, there can be a relatively short linear-distance between an output of the first DAC and an input of the x-ray tube control circuit for the first DAC and between an output of the second DAC and an input of the x-ray tube control circuit for the second DAC.

In another embodiment, the power supply can include an electronic circuit consisting of a single circuit board with associated electronic components mounted thereon or multiple circuit boards rigidly-mounted together with associated electronic components mounted thereon. The electronic components on the circuit board (or these multiple circuit boards rigidly-mounted together) can comprise the digital controller, the first DAC, the second DAC, and the x-ray tube control circuit.

In another embodiment, the digital controller, the first DAC, the second DAC, and the x-ray tube control circuit can be rigidly-mounted within a housing.

### BRIEF DESCRIPTION OF THE DRAWINGS (DRAWINGS MIGHT NOT BE DRAWN TO SCALE)

FIG. 1 is a schematic of a power supply for an x-ray tube, andi a cross-sectional side-view of the x-ray tube, in accordance with an embodiment of the present invention.

FIG. 2 is a schematic of a power supply for an x-ray tube, a housing for components of the power supply, and a cross-sectional side-view of the x-ray tube rigidly-mounted to the power supply, in accordance with an embodiment of the present invention.

FIG. 3 is a schematic of part of a power supply for an x-ray tube, showing digital-to-analog converters, analog-to-digital converters, and an x-ray tube control circuit, in accordance with an embodiment of the present invention.

### DETAILED DESCRIPTION

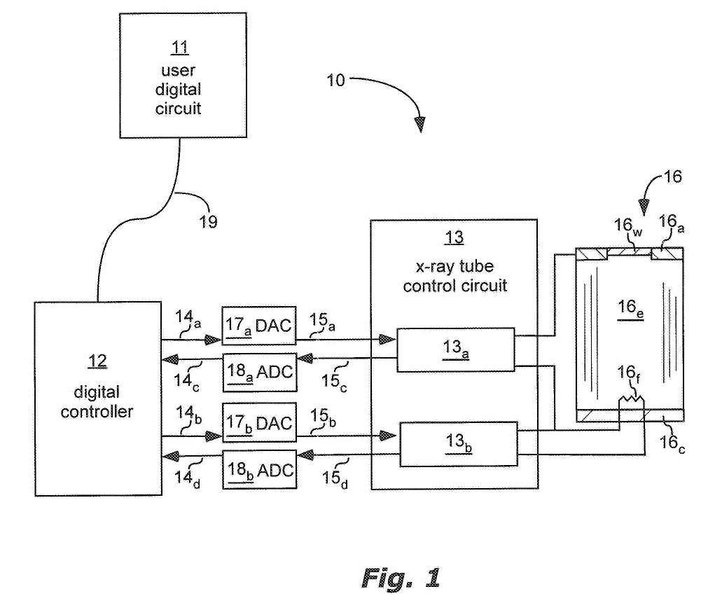

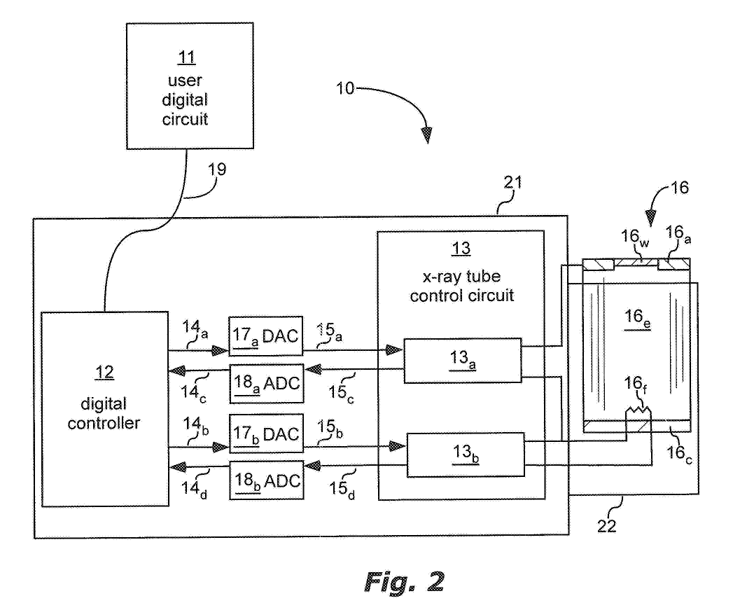

As illustrated in FIGS. 1-2, an x-ray source can comprise a power supply 10 electrically-coupled to an x-ray tube 16. The x-ray tube 16 can be rigidly-mounted to the power supply 10. Also illustrated in FIGS. 1-2 is a user digital circuit 11 that can provide digital controls to the power supply 10.

The x-ray tube 16 can include a cathode 16_{c} that is electrically-insulated from an anode 16ₐ, such as by an electrically-insulative enclosure 16ₑ (e.g. ceramic or glass). The cathode 16_{c} can include an electron emitter 16_{f} (e.g.

filament) capable of emitting electrons to the anode 16ₐ. The anode 16ₐ can include a target material capable of emission of x-rays in response to impinging electrons from the electron emitter 16_{f}.

The x-ray tube 16 can include a window 16_{w} for transmission of the x-rays outside of the x-ray tube 16. A transmission-target x-ray tube 16 is shown in the figures. The invention is also applicable to a side-window x-ray tube. The x-ray window 16 can include some or all of the properties (e.g. low deflection, high x-ray transmissivity, low visible and infrared light transmissivity) of the x-ray window described in U.S. Patent Publication Number 2015/0303024, which is incorporated herein by reference in its entirety.

The power supply 10 can include a digital controller 12, a first digital-to-analog converter, defining a first DAC 17ₐ, a second digital-to-analog converter, defining a second DAC 17_{b}, and an x-ray tube control circuit 13. The digital controller 12 can emit a first digital signal 14ₐ to indicate a desired x-ray tube 16 voltage and a second digital signal 14_{b} to indicate a desired x-ray tube 16 electrical current for the electron emitter 16_{f}. The first DAC 17, can be electrically-coupled to the digital controller 12, can receive the first digital signal 14ₐ, and can emit a voltage corresponding to the first digital signal 14ₐ, defining a first analog signal 15ₐ. The second DAC 17_{b} can be electrically-coupled to the digital controller 12, can receive the second digital signal 14_{b}, and can emit a voltage corresponding to the second digital signal 14_{b}, defining a second analog signal 15_{b}.

The x-ray tube control circuit 13 can be electrically-coupled to the first DAC 17ₐ, can receive the first analog signal 15ₐ, and can provide a voltage differential to the x-ray tube 16 (e.g. between the cathode 16_{c} and the anode 16ₐ) based on the first analog signal 15ₐ. This voltage differential can be large enough to be a cause of electron emission from the electron emitter 16_{f} to the anode 16ₐ. Examples of the magnitude of this voltage differential include >1 kV in one aspect, >4 kV in another aspect, or >9 kV in another aspect. For example, a portion of the x-ray tube control circuit 13 that can receive the first analog signal 15ₐ and can provide the voltage differential can be a high-voltage generator 13ₐ, such as a Cockcroft-Walton generator or multiplier.

The x-ray tube control circuit 13 can also be electrically-coupled to the second DAC 17_{b}, can receive the second analog signal 15_{b}, and can provide an electrical current to the electron emitter 16_{f} based on the second analog signal 15_{b}. For example, a portion of the x-ray tube control circuit 13 that can receive the second analog signal 15_{b} and can provide the electrical current to the electron emitter 16_{f} can be an electrical current source 13_{b}, typically be an alternating current source.

Actual voltage and electrical current provided to the x-ray tube 16 can vary from desired, so feedback to the digital controller 12 can allow the digital controller 12 to adjust the first digital signal 14ₐ and the second digital signal 14_{b} so that actual voltage and electrical current can equal, or at least be closer to, desired voltage and electrical current. To accomplish this objective, the power supply 10 can further comprise a first analog-to-digital converter, defining a first ADC 18ₐ, to provide feedback to the digital controller 12 of actual x-ray tube 16 voltage, and a second analog-to-digital converter, defining a second ADC 18_{b} to provide feedback to the digital controller 12 of actual electrical current through the electron emitter 16_{f}.

The first ADC 18ₐ can be electrically-coupled to the x-ray tube control circuit 13 and to the digital controller 12. The first ADC 18ₐ can convert an analog signal received from the x-ray tube control circuit 13, defining a third analog signal 15_{c}, into a digital signal, defining a third digital signal 14_{c}. The third analog signal 15_{c} and the third digital signal 14_{c} can provide feedback to the digital controller 12 of actual x-ray tube 16 voltage. The digital controller 12 can then adjust the first digital signal 14ₐ based on the third digital signal 14_{c} received from the first ADC 18ₐ.

The second ADC 18_{b} can be electrically-coupled to the x-ray tube control circuit 13 and to the digital controller 12. The second ADC 18_{b} can convert an analog signal received from the x-ray tube control circuit 13, defining a fourth analog signal 15_{d}, into, a digital signal, defining a fourth digital signal 14_{d}. The fourth analog signal 15_{d} and the fourth digital signal 14_{d} can provide feedback to the digital controller 12 of actual electrical current through the electron emitter 16_{f}. The digital controller 12 can then adjust the second digital signal 14_{b} based on the fourth digital signal 14_{d} received from the second ADC 18_{b}.

Some or all of the following electronic components of the power supply 10 can be part of an electronic circuit mounted on a single circuit board with associated electronic components mounted thereon or multiple circuit boards rigidly-mounted together: the digital controller 12, the first DAC 17ₐ, the second DAC 17_{b}, the x-ray tube control circuit 13, the first ADC 18ₐ, and the second ADC 18_{b}. Placing these electronic components on a single circuit board with associated electronic components mounted thereon or multiple circuit boards rigidly-mounted together can allow them to be located in close proximity to each other, reducing electronic noise that otherwise could result from transferring electricity across larger distances.

Some or all of these components of the power supply 10 (the digital controller 12, the first DAC 17ₐ, the second DAC 17_{b}, the x-ray tube control circuit 13, the first ADC 18ₐ, and the second ADC 18_{b}) can be rigidly-mounted within a housing 21. The housing 21 can be a single housing. The housing 21 can be relatively small. For example, the housing 21 can have an internal volume of less than 100 cm³ in one aspect, less than 1000 cm³ in another aspect, less than 5000 cm³ in another aspect, less than 10,000 cm³ in another aspect, or less than 30,000 cm³ in another aspect. The housing 21 can be electrically-conductive and can be metallic, to allow transfer of electric charges to ground, for heat transfer, and to shield the electronic components therein. Placing these electronic components in a single housing 21 can allow them to be located in close proximity to each other, reducing electronic noise that otherwise could result from transferring electricity across larger distances.

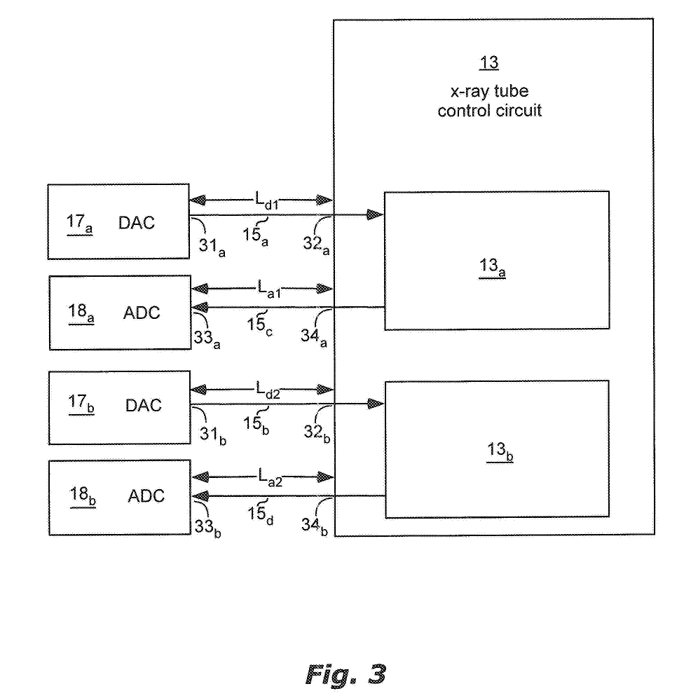

As shown in FIG. 3, there can be a relatively short linear-distance L_{d1} between an output 31ₐ of the first DAC 17ₐ and an input 32ₐ of the x-ray tube control circuit 13 for the first DAC 17ₐ. There can be a relatively short linear-distance L_{d2} between an output 31_{b} of the second DAC 17_{b} and the input 32_{b} of the x-ray tube control circuit 13 for the second DAC 17_{b}. There can be a relatively short linear-distance Lₐ₁ between an output 34ₐ of the x-ray tube control circuit 13 for the first ADC 18ₐ and an input of the first ADC 18ₐ. There can be a relatively short linear-distance Lₐ₂ between an output 34_{b} of the x-ray tube control circuit 13 for the second ADC 18_{b} and the input of the second ADC 18_{b}. For example, these linear-distances L_{d1}, L_{d2}, Lₐ₁, and Lₐ₂ can each have a maximum length of less than 0.5 centimeters in one aspect, less than one centimeter in another aspect, less than two centimeters in another aspect, less than three centimeters in another aspect, or less than five centimeters in another aspect. Placing these electronic components in close proximity to each other can reduce electronic noise that otherwise could result from transferring electricity across larger distances.

Operation of the x-ray sources described herein can be relatively easier for the user. The x-ray source manufacturer can make the x-ray tube 16 and power supply 10, capable of electrically-coupling to a user digital circuit 11 and receiving digital signals 19 of user-desired x-ray tube 16 voltage and x-ray tube 16 electrical current from the user digital circuit 11. The digital controller 12 can then emit the first digital signal 14ₐ and the second digital signal 14_{b} based on these digital signals 19 from the user. The user thus does not need to provide analog signals. Also, the user does not need to be concerned with variation between x-ray tubes. The x-ray source manufacturer can calibrate each x-ray tube 16 to its power supply 10.

Another benefit of the x-ray sources described herein is the ability for the x-ray source manufacturer to record and use certain information to improve the x-ray sources. For example, the digital controller 12 can record and export duration of x-ray tube 16 operation, number of times the x-ray tube 16 has been energized, faults, or combinations thereof. Such export can be digital signal(s) to the user digital circuit 11.

What is claimed is:

1. A power supply for an x-ray tube, the power supply comprising:
a) a digital controller capable of emitting a first digital signal to indicate a desired x-ray tube voltage and a second digital signal to indicate a desired x-ray tube electrical current for an electron emitter;
b) a first digital-to-analog converter, defining a first DAC, electrically-coupled to the digital controller, capable of receiving the first digital signal, and capable of emitting a voltage corresponding to the first digital signal, defining a first analog signal;
c) a second digital-to-analog converter, defining a second DAC, electrically-coupled to the digital controller, capable of receiving the second digital signal, and capable of emitting a voltage corresponding to the second digital signal, defining a second analog signal;
d) an x-ray tube control circuit:
i) electrically-coupled to the first DAC and capable of receiving the first analog signal and providing a voltage differential, of at least 1 kilovolt, to the x-ray tube, based on the first analog signal;
ii) electrically-coupled to the second DAC and capable of receiving the second analog signal and providing an electrical current to the electron emitter based on the second analog signal;
e) a maximum linear-distance between an output of the first DAC and an input of the x-ray tube control circuit for the first DAC is less than three centimeters; and
f) a maximum linear-distance between an output of the second DAC and an input of the x-ray tube control circuit for the second DAC is less than three centimeters.

2. The power supply of claim 1, further comprising:
a) a first analog-to-digital converter, defining a first ADC:
i) electrically-coupled to the x-ray tube control circuit and to the digital controller;
ii) capable of converting an analog signal received from the x-ray tube control circuit, defining a third analog signal, into a digital signal, defining a third digital signal, the third analog signal and the third digital signal providing feedback to the digital controller of actual x-ray tube voltage;
b) a second analog-to-digital converter, defining a second ADC:
i) electrically-coupled to the x-ray tube control circuit and to the digital controller;
ii) capable of converting an analog signal received from the x-ray tube control circuit, defining a fourth analog signal, into a digital signal, defining a fourth digital signal, the fourth analog signal and the fourth digital signal providing feedback to the digital controller of actual electrical current through the electron emitter;
c) the digital controller:
i) capable of adjusting the first digital signal based on the third digital signal received from the first ADC;
ii) capable of adjusting the second digital signal based on the fourth digital signal received from the second ADC; and
d) a maximum linear-distance between an output of the x-ray tube control circuit for the first ADC and an input of the first ADC is less than three centimeters; and
e) a maximum linear-distance between an output of the x-ray tube control circuit for the second ADC and an input of the second ADC is less than three centimeters.

3. The power supply of claim 2, wherein:
a) the maximum linear-distance between the output of the x-ray tube control circuit for the first ADC and the input of the first ADC is less than two centimeters; and
b) the maximum linear-distance between the output of the x-ray tube control circuit for the second ADC and the input of the second ADC is less than two centimeters.

4. The power supply of claim 1, wherein:
a) the maximum linear-distance between the output of the first DAC and the input of the x-ray tube control circuit for the first DAC is less than two centimeters; and
b) the maximum linear-distance between the output of the second DAC and the input of the x-ray tube control circuit for the second DAC is less than two centimeters.

5. The power supply of claim 1, wherein the power supply forms part of an x-ray source, the x-ray source comprising the x-ray tube electrically-coupled to the power supply.

6. The x-ray source of claim 5, wherein the x-ray tube is rigidly-mounted to the power supply.

7. The power supply of claim 1, wherein the digital controller is capable of:
a) electrically-coupling to a user digital circuit;
b) receiving digital signals of user-desired x-ray tube voltage and x-ray tube electrical current from the user digital circuit; and
c) emitting the first digital signal and the second digital signal based on the digital signals of user-desired x-ray tube voltage and x-ray tube electrical current.

8. The power supply of claim 1, wherein the digital controller is capable of recording and exporting duration of x-ray tube operation, number of times the x-ray tube has been energized, faults, or combinations thereof.

9. The power supply of claim 1, further comprising a housing, and wherein:
a) the housing has an internal volume of less than 5000 cm³;
b) the housing is electrically-conductive; and
c) the digital controller, the first DAC, the second DAC, and the x-ray tube control circuit are rigidly-mounted within the housing.

10. The power supply of claim 1, wherein the digital controller, the first DAC, the second DAC, and the x-ray tube control circuit are electronic components mounted on a single circuit board or on multiple circuit boards rigidly-mounted together.

11. A power supply for an x-ray tube, the power supply comprising an electronic circuit, the electronic circuit consisting of a single circuit board with associated electronic components mounted thereon or multiple circuit boards rigidly-mounted together with associated electronic components mounted thereon, the electronic components comprising:
a) a digital controller capable of emitting a first digital signal to indicate a desired x-ray tube voltage and a second digital signal to indicate a desired x-ray tube electrical current;
b) a first digital-to-analog converter, defining a first DAC, electrically-coupled to the digital controller, capable of receiving the first digital signal, and capable of emitting a first analog signal corresponding to the first digital signal;
c) a second digital-to-analog converter, defining a second DAC, electrically-coupled to the digital controller, capable of receiving the second digital signal, and capable of emitting a second analog signal corresponding to the second digital signal;
d) an x-ray tube control circuit:
i) electrically-coupled to the first DAC and capable of receiving the first analog signal and providing a voltage differential, of at least 1 kilovolt, to the x-ray tube, based on the first analog signal; and
ii) electrically-coupled to the second DAC and capable of receiving the second analog signal and providing an electrical current to the x-ray tube based on the second analog signal.

12. The power supply of claim 11, further comprising a housing, and wherein:
a) the housing has an internal volume of less than 5000 cm³;
b) the housing is electrically-conductive; and
c) the digital controller, the first DAC, the second DAC, and the x-ray tube control circuit are rigidly-mounted within the housing.

13. The power supply of claim 11, wherein the power supply forms part of an x-ray source, the x-ray source comprising the x-ray tube electrically-coupled to the power supply.

14. The power supply of claim 11, further comprising:
a) a first analog-to-digital converter, defining a first ADC:
i) electrically-coupled to the x-ray tube control circuit and to the digital controller;
ii) capable of converting an analog signal received from the x-ray tube control circuit, defining a third analog signal, into a digital signal, defining a third digital signal, the third analog signal and the third digital signal providing feedback to the digital controller of actual x-ray tube voltage;
b) a second analog-to-digital converter, defining a second ADC:
i) electrically-coupled to the x-ray tube control circuit and to the digital controller;
ii) capable of converting an analog signal received from the x-ray tube control circuit, defining a fourth analog signal, into a digital signal, defining a fourth digital signal, the fourth analog signal and the fourth digital signal providing feedback to the digital controller of actual electrical current through the electron emitter;
c) the digital controller:
i) capable of adjusting the first digital signal based on the third digital signal received from the first ADC;
ii) capable of adjusting the second digital signal based on the fourth digital signal received from the second ADC; and
d) a maximum linear-distance between an output of the x-ray tube control circuit for the first ADC and an input of the first ADC is less than three centimeters; and
e) a maximum linear-distance between an output of the x-ray tube control circuit for the second ADC and an input, of the second ADC is less than three centimeters.

15. A power supply for an x-ray tube, the power supply comprising:
a) a housing;
b) a digital controller, rigidly-mounted within the housing, and capable of emitting a first digital signal to indicate a desired x-ray tube voltage and a second digital signal to indicate a desired x-ray tube electrical current for an electron emitter;
c) a first digital-to-analog converter, defining a first DAC, rigidly-mounted within the housing, electrically-coupled to the digital controller, capable of receiving the first digital signal, and capable of emitting a first analog signal corresponding to the first digital signal;
d) a second digital-to-analog converter, defining a second DAC, rigidly-mounted within the housing, electrically-coupled to the digital controller, capable of receiving the second digital signal, and capable of emitting a second analog signal corresponding to the second digital signal; and
e) an x-ray tube control circuit:
i) rigidly-mounted within the housing;
ii) electrically-coupled to the first DAC and capable of receiving the first analog signal and providing a voltage differential, of at least 1 kilovolt, to the x-ray tube, based on the first analog signal; and
iii) electrically-coupled to the second DAC and capable of receiving the second analog signal and providing an electrical current to the electron emitter based on the second analog signal.

16. The power supply of claim 15, wherein the housing has an internal volume of less than 5000 cm³.

17. The power supply of claim 15, wherein the housing is electrically-conductive.

18. The power supply of claim 15, wherein the power supply forms part of an x-ray source, the x-ray source comprising the x-ray tube electrically-coupled to the power supply.

19. The power supply of claim 15, further comprising:
a) a first analog-to-digital converter, defining a first ADC:
i) electrically-coupled to the x-ray tube control circuit and to the digital controller;
ii) capable of converting an analog signal received from the x-ray tube control circuit, defining a third analog signal, into a digital signal, defining a third digital signal, the third analog signal and the third digital signal providing feedback to the digital controller of actual x-ray tube voltage;
b) a second analog-to-digital converter, defining a second ADC:
i) electrically-coupled to the x-ray tube control circuit and to the digital controller;
ii) capable of converting an analog signal received from the x-ray tube control circuit, defining a fourth analog signal, into a digital signal, defining a fourth digital signal, the fourth analog signal and the fourth digital signal providing feedback to the digital controller of actual electrical current through the electron emitter;
c) the digital controller:
i) capable of adjusting the first digital signal based on the third digital signal received from the first ADC;
ii) capable of adjusting the second digital signal based on the fourth digital signal received from the second ADC; and
d) a maximum linear-distance between an output of the x-ray tube control circuit for the first ADC and an input of the first ADC is less than three centimeters; and
e) a maximum linear-distance between an output of the x-ray tube control circuit for the second ADC and an input of the second ADC is less than three centimeters.

20. The power supply of claim 15, wherein the digital controller is capable of:
a) electrically-coupling to a user digital circuit;
b) receiving digital signals of user-desired x-ray tube voltage and x-ray tube electrical current from the user digital circuit; and
c) emitting the first digital signal and the second digital signal based on the digital signals of user-desired x-ray tube voltage and x-ray tube electrical current.
